(19) United States
(12) Patent Application Publication
(10) Pub. No.: US 2005/0241589 A1
(43) Pub. Date: Nov. 3, 2005

(54) Method for determining a quantity of liquid nutriments consumed by animals

(76) Inventor: Martin Forster, Engen (DE)

Correspondence Address: BACHMAN & LAPOINTE, P.C., 900 CHAPEL STREET, SUITE 1201, NEW HAVEN, CT, 06510, US

(21) Appl. No.: 10/513,641

(22) PCT Filed: May 5, 2003
(86) PCT No.: PCT/EP03/04674

§ 371 Date: May 20, 2005

(30) Foreign Application Priority Data
Jul. 8, 2002 (DE) 102 20 729.1

(51) Int. Cl. A01K 7/02

(52) U.S. Cl. 119/74

(57) ABSTRACT

A method for determining a quantity of liquid food which has been drunk by animals, in particular water or milk from a drinking dish (2), the liquid food being fed into the latter, characterized in that a preselected, determinable quantity of liquid food is fed into the drinking dish (2) and, after the food has been removed by an animal, the quantity of liquid food which has actually been drunk is ascertained exactly by means of a filling-level measurement, by means of a filling-level-measuring device (7), on an individual animal basis after drinking has taken place, and the preselected, determined quantity of liquid food is fed in via a reservoir (14), which is connected to the drinking dish (2) via at least one connecting conduit (13), and a filling level, an ascertaining of a residual quantity and/or a speed of removal of the food from the drinking dish (2) is ascertained, regulated and/or controlled there.

### BACKGROUND OF THE INVENTION

The present invention relates to a method for determining a quantity of liquid food which has been drunk by animals, in particular water or milk from a drinking dish, the liquid food being fed into the latter, and to a device for carrying out the method.

In the case of conventional methods, food is supplied to a container, for example a drinking dish, with it being possible, for example, for a maximum filling state of the drinking dish to be indicated via a sensor.

A disadvantage of this is that the exact ascertaining of a quantity of food which has been drunk by the animal, in particular on an individual animal basis, is not possible.

It is furthermore disadvantageous that conventional drinking dishes are difficult to clean and cannot be filled on an individual animal basis.

EP 0 715 806 A1 discloses a method for feeding animals, in particular fattening animals, the feed being transported to individual animals or to a group of animals at their feed-dispensing point via at least one conduit, the intention being to take the feed which has been removed into consideration in the future feeding. In this case, a theoretical requirement of the animal for feed is ascertained from a feed curve, based on the age and/or weight of the animal.

U.S. Pat. No. 6,371,047 B1 discloses a feed and/or drinking column for animals, in which corresponding removal points are arranged in the manner of a circular ring around the column, and the removal points are connected to a weighing device in order to ascertain the quantity of feed which has been poured in.

### SUMMARY OF THE INVENTION

The present invention is based on the object of providing a method or a device of the type mentioned at the beginning, which eliminates the disadvantages mentioned and with which an exact quantity of food which has been drunk can be determined on an individual animal basis in a simple, cost-effective and effective manner.

This object is achieved by the features of patent claim 1 and of subordinate patent claim 11.

In the present invention, liquid food is supplied to a drinking dish in a predeterminable quantity on an individual animal basis. In particular, an exact, preselected and optionally preportioned quantity of liquid food is supplied to the drinking dish, so that the quantity of liquid food in the drinking dish is known exactly.

When the animal begins to consume food from the drinking dish, then corresponding filling-level-measuring devices and/or a quantity-measuring device can be used to exactly determine how much food has been consumed from the drinking dish on an individual animal basis. This enables a conclusion to be made about the quantity of food which has actually been drunk. This can be determined exactly.

In particular, a residual-quantity measurement after an animal has drunk from the drinking dish can be used, since the predetermined quantity of food is known, to exactly ascertain how much food has been drunk by the animal.

If, for example, the animal completely finishes the drinking dish, then a further, predetermined quantity of food can be supplied, if appropriate at intervals, for drinking. However, this quantity may be supplied to the drinking dish in predetermined, smaller quantities.

This makes it possible to absolutely exactly determine the quantity of food which has actually been drunk from the drinking dish by each animal, as a result of which an influence on the exact feed quantity for each animal can be exerted on an individual animal basis. For example, the maximum quantity of food can be controlled or determined here on an individual animal basis. It is also conceivable for the animal to be able to take in very specific, selectable quantities of food only at very specific times of the day.

It has furthermore proven advantageous additionally to assign to the drinking trough a discharge line having an activatable discharge valve in order, if appropriate, to empty a residual quantity from the drinking dish, for example at the end of a day, and/or to automatically discharge cleaning liquid or cleaning agents out of the drinking dish.

In a further exemplary embodiment of the present invention, a reservoir which is connected via a connecting conduit, which is connected to the drinking dish in the bottom region, is connected externally to the drinking dish.

The drinking dish and reservoir are connected to each other via “communicating pipes”. It has turned out to be particularly advantageous, in particular, to carry out the supply of food from the food source via the reservoir.

From there, the food flows via the connecting conduit into the bottom region of the drinking dish.

Corresponding pressure sensors and/or mechanical float devices, which ascertain the actual filling state, are preferably provided in the reservoir. These pressure sensors and/or float devices can be used not only to carry out an ascertaining of the filling state or else an ascertaining of the residual quantity, but also the speed of removal of food from the drinking dish can be determined exactly on an individual animal basis.

Furthermore, the top-up speed and/or portion size of food to be supplied into the reservoir can likewise be exactly regulated and controlled or determined by this means, after the speed of removal has been determined. This is to likewise lie within the scope of the present invention.

The reservoir is preferably arranged outside a region which is accessible to or reachable by animals, so that in this manner sensors, float devices, valves etc. cannot be damaged by animals.

In addition, they can very easily be maintained or replaced outside an access region.

### BRIEF DESCRIPTION OF THE DRAWING

Further advantages, features and details of the invention emerge from the following description of preferred exemplary embodiments and with reference to the drawing, in which,

FIG. 1 shows a schematically illustrated side view of a device for removing liquid food, in particular a drinking dish;

FIG. 2 shows a schematically illustrated side view of a further exemplary embodiment of the device for removing liquid food according to FIG. 1.

### DETAILED DESCRIPTION

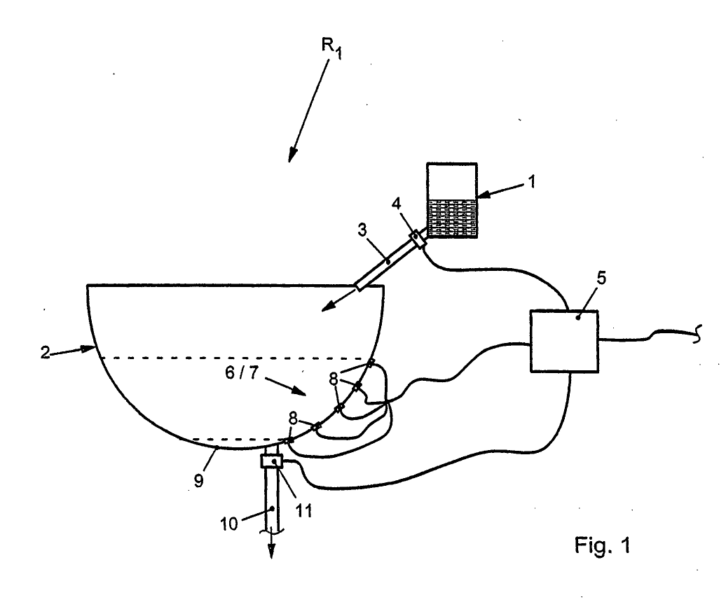

According to FIG. 1, a device R₁ according to the invention for removing liquid food from a food source 1 has a drinking dish 2, the food being fed from the food source 2 into the latter via a supply line 3. In the exemplary embodiment of the present invention, the food can be supplied from the food source 1 to the drinking dish 2 via an activatable valve 4.

The valve 4 can be activated via a controller 5.

Furthermore, the drinking dish is assigned a quantity-measuring device and/or filling-level-measuring device 6, 7 which can be formed from a plurality of sensors 8, filling-level sensors or pressure sensors arranged on different levels.

The quantity-measuring device 6 and/or filling-level-measuring device 7 may also be, for example, scales or the like.

Furthermore, a discharge line 10 is connected to the drinking dish 2 in a bottom region 9, it being possible for residual remaining food and/or cleaning liquid for cleaning purposes to be discharged from the drinking dish 2 via a discharge valve 10.

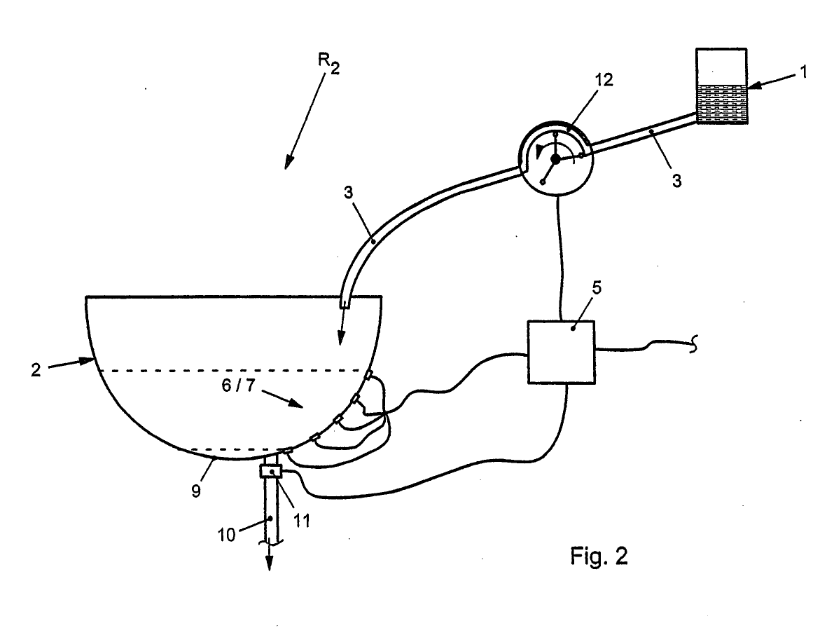

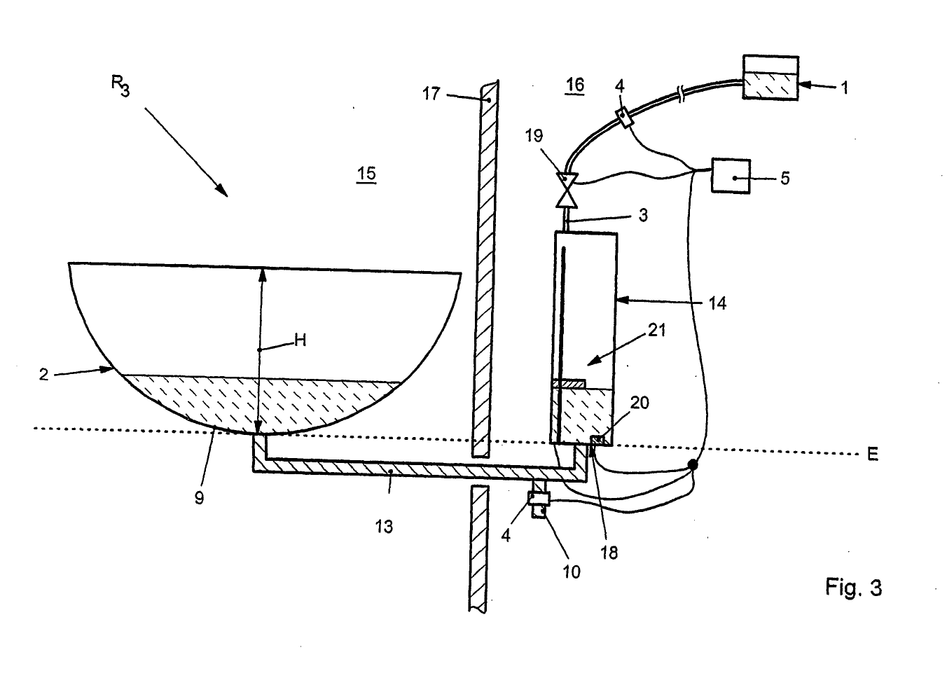

In the exemplary embodiment of the invention according to FIG. 2, a device R₂ is shown, a hose pump 12 being inserted instead of the valve 4 into the supply line 3 to conduct liquid food from the food source 1 into the drinking dish 2. The hose pump 12 enables a predeterminable, exactly ascertainable quantity of food to be conducted from the food source 1 into the drinking dish.

The functioning of the invention is as follows:

In the case of the present invention, a preselected or determinable quantity of liquid food, for example water or milk, or liquid food mixed with appropriate nutrients or liquid food prepared in any desired food source is supplied to a drinking dish for the purpose of animal feeding or animal fattening. For example, a liter of liquid food is fed into a drinking dish in an exactly determined manner. This can take place in any desired manner. For example, a quantity of food can be supplied via a container in an exactly determinable manner to the drinking trough via the opening side of a valve. It is also conceivable for an exactly preselected quantity of food to be supplied to the drinking trough by means of a hose pump.

The animal can then take in, on an individual animal basis, this determined quantity of food at the removal point or at the drinking trough, in particular at the dish-type drinking trough. A corresponding transponder, as is conventionally already known, can be used to ascertain which animal precisely is removing food from the drinking dish.

If the animal, for example, completely drinks the predetermined and exactly preportioned quantity of food from the drinking dish, then, in a further step, a further quantity of food can be supplied in a selectable and determinable manner to the drinking dish on an individual animal basis. It has proven advantageous to supply this second quantity of liquid food into the drinking dish in a smaller quantity for the same animal.

If the quantity of liquid food that is to be removed is sufficient for the animal, then no further food is supplied to it.

If the animal does not completely drink the food from the drinking dish, then a quantity-measuring device or filling-level-measuring device is used either to ascertain the quantity of liquid food which has actually been drunk or to exactly determine the residual quantity of food remaining in the drinking dish. Owing to the fact that the quantity of food which has been poured into the drinking dish was known in advance, the quantity of food which has actually been drunk can be ascertained exactly and on an individual animal basis. This makes it possible to exactly determine which animal has taken in how much food and when. This is of importance in particular when raising young animals.

In addition, the animal's state of health can also be monitored by this manner of feeding.

If the animal leaves a certain quantity of food as a residual quantity in the drinking dish, then this can likewise be ascertained exactly in the above-described manner. If the next animal comes to the removal point or to the dish-type drinking trough, then the preselected or predeterminable quantity of liquid food for the animal is fed into the drinking dish and, in addition, the residual quantity is credited to this animal. After the corresponding removal, the quantity of food which has actually been drunk can then be ascertained on an individual animal basis in the above-described manner by means of a filling-level measurement and/or residual-quantity measurement. This is likewise to lie within the scope of the present invention.

In order to ascertain the residual quantity, it is possible, for example, for a multiplicity of sensors arranged on different levels, for example filling-level sensors and/or pressure sensors, to be assigned to the drinking dish in order to exactly ascertain in the drinking trough the residual quantity or the quantity of food which has actually been drunk, if to start with, a specific, predetermined quantity of food has been fed into the drinking dish.

Furthermore, the scope of the present invention is also to include the fact that an appropriate preportioning of the liquid food can take place in an additional container between the food source and drinking dish.

A discharge line can also be opened via a discharge valve for hygienic reasons, and also for cleaning purposes. The discharge line is connected to the drinking dish 2 preferably in the bottom region 9. A controller 5 can be used to open the discharge valve 11 correspondingly for cleaning purposes or for emptying the drinking dish.

In a further preferred exemplary embodiment of the invention according to FIG. 3, a device R₃ is shown, in which a connecting conduit 13, which is connected to an external, column-like reservoir 14, is connected to a drinking dish 2, preferably in the bottom region 9.

The reservoir 14 is preferably separated locally from the drinking dish 2, the drinking dish 2 being arranged, for example, in a stall region 15 and the reservoir 14 being arranged in a region 16 which is not accessible to or cannot be reached by animals. In this case, for example, a partition 17 (merely indicated here) can be used to divide up the stall region 15 and the region which cannot be reached by or is not accessible to animals 16.

The reservoir 14 is preferably at least at the same height H as the drinking dish 2.

The bottom region 9 is situated approximately in a common plane E with a bottom 18 of the reservoir 14.

A supply line 3 leads into the reservoir 14, a valve 4 and a pressure reducer 19 (indicated here) ensuring a constant inflow of food from a container 1 (indicated here) into the reservoir 14.

A controller 5 takes on the corresponding activation of the valve 4 and of the pressure reducer 19.

The food 1, which may also be water, can be supplied to the column-like reservoir 14, preferably in desired, predetermined quantities.

In this case, at least one pressure sensor 20 can be assigned to the reservoir 14 as filling-level sensor, a mechanical float device 21, for example, also indicating the filling level in the reservoir 14. The pressure sensor 20 and/or float device 21 are connected to the controller 5 via connecting conduits (merely indicated here) or via a bus system.

It is advantageous in the case of the present invention, that, for example, a preselected quantity of food is supplied from the food source 1 to the reservoir 14, if appropriate also cyclically. If, for example, the food is then removed from the drinking dish 2 by the animal, then the quantity of food which has been drunk from the drinking dish 2 can be exactly ascertained via the pressure sensor 20 and/or the float device 21.

The drinking speed can be determined on an individual animal basis via the pressure differential or also the speed of removal of the food or the change in the filling state in the float device 21. This enables the controller 5 to exert an influence on a further supply of food into the reservoir 14. Also via the quantity or also supply speed of the food, it is possible here for there to be an influence on an individual animal basis.

The food, in particular water, can be fed into or added to the column- or cylinder-like reservoir 14 via preselectable or preselected opening times of the valve 4. After the food has been removed from the drinking dish 2, the corresponding ascertaining of the filling level or residual quantity by means of the negative pressure sensor 20 or the float device 21 is used, in accordance with the principle of communicating pipes between the drinking dish 2 and reservoir 14, to ascertain the residual quantity which remains in the drinking dish 2, from which then the quantity of food which has actually been drunk can be exactly and individually determined.

It is advantageous, in the case of the present exemplary embodiment, that a food supply and also a determination of the actual filling state, a drinking speed, or an ascertaining of a residual quantity take place outside the stall region 15 in a region 16 which cannot be reached by or is not accessible to animals, with the result that sensitive pressure sensors, quantity-measuring elements, for example the float device, and also the supply lines 3, valves 4, controller 5 or pressure reducers 19 cannot be damaged by animals.

The scope of the present invention is also to include the fact that, for example in the region of the connecting conduit 13, a discharge line is connected to the connecting conduit 13 preferably in the region 16. A valve 4 can be inserted in the discharge line 10 in a manner such that it can be activated via the controller 5. However, for example, a residual quantity in the drinking dish 2 or in the reservoir 14 is also to be able to be discharged for cleaning purposes. Via the controller 5, the discharge line 10 can be opened.

It is furthermore to be intended that an adaptation of the inflow speed of the food into the reservoir 14 takes place on an individual animal basis as a function of the drinking speed which has actually been measured and ascertained. By means of appropriate sensor technology, the drinking speed can be ascertained on an individual animal basis via an ascertaining of the change in pressure at the pressure sensor 19 or by the corresponding movement of the float device 21 per unit of time. This enables the top-up speed and/or portion size of the food from the food source 1 into the reservoir 14 and therefore into the drinking dish 2 to be exactly and precisely regulated and controlled while drinking takes place. This is likewise to be included within the scope of the present invention.

Other filling-level-measuring systems are intended also to be able to determine the filling level, the filling-level changes and therefore the speed of removal in the reservoir 14. It is intended that, for example, ultrasound, light, laser or infrared filling-level-measuring systems, which, if appropriate, also determine the distance of the liquid in the reservoir from the surface or the changing distance of it from the surface, can be used.

1. A method for determining a quantity of liquid food which has been drunk by animals, in particular water or milk from a drinking dish (2), the liquid food being fed into the latter, characterized in that a preselected, determinable quantity of liquid food is fed into the drinking dish (2) and, after the food has been removed by an animal, the quantity of liquid food which has actually been drunk is ascertained exactly by means of a filling-level measurement, by means of a filling-level-measuring device (7), on an individual animal basis after drinking has taken place, and the preselected, determined quantity of liquid food is fed in via a reservoir (14), which is connected to the drinking dish (2) via at least one connecting conduit (13), and a filling level, an ascertaining of a residual quantity and/or a speed of removal of the food from the drinking dish (2) is ascertained, regulated and/or controlled there.

2. The method as claimed in claim 1, characterized in that the supply of a specific, preselected quantity of liquid food into the drinking dish (2) makes it possible to use a residual quantity measurement, after liquid food has been removed from the drinking dish (2), to ascertain the quantity of liquid food which has actually been drunk and, by this means, to be able to determine and/or ascertain the quantity of liquid food which has actually been drunk by the animal in an exact manner on an individual animal basis.

3. The method as claimed in claim 1, characterized in that after a preselected and predetermined quantity of liquid food has been poured into the drinking dish (2) and after a subsequent removal of the food from the drinking dish (2) by an animal, a preselected, determinable quantity of liquid food is supplied again to the drinking dish (2) on an individual animal basis.

4. The method as claimed in claim 3, characterized in that when further supplying liquid food to the drinking dish (2), if the animal has completely drunk the first quantity, a smaller quantity of liquid food is predetermined and poured into the drinking dish (2) on an individual animal basis.

5. The method as claimed in claim 1, characterized in that when it is ascertained that a quantity remains in the drinking dish (2), the residual quantity is ascertained and added or credited to the next animal drinking at the drinking dish (2).

6. The method as claimed in claim 4, characterized in that when a residual quantity of food remains in the drinking dish (2), a preselected, determinable quantity of food minus the quantity of food remaining in the drinking dish is supplied for the next animal.

7. The method as claimed in claim 1, characterized in that a residual quantity of food remaining in the drinking dish (2) and/or a liquid for cleaning the drinking dish (2) is discharged via an activatable discharge valve (11).

8. The method as claimed in claim 1, characterized in that an ascertaining of the residual quantity is carried out by means of sensors, filling-level sensors (8), scales and/or pressure sensors, at least one pressure sensor (20) and/or at least one float device (21) being provided in the reservoir.

9. The method as claimed in claim 1, characterized in that after the speed of removal of the food from the drinking dish (2) has been ascertained, a top-up speed and/or portion size of the food to be supplied from the food source (1) is regulated, adapted or parameterized.

10. The method as claimed in claim 1, characterized in that a reservoir (14) via which a supply of food from a food source (1) into the reservoir (14) and a regulation of the supply speed and an ascertaining of the residual quantity take place outside a region (16) which can be reached by or is accessible to animals, is connected to the drinking dish (2).

11. A device for animals for removing liquid food, in particular drinking dish (2), which food can be supplied from a food source (1), characterized in that the food can be supplied from the food source (1) to the drinking dish (2) in a preselected, determinable quantity, and the drinking dish (2) is assigned at least one filling-level-measuring device (7), an external reservoir (14) being connected to the drinking dish (2) via a connecting conduit (13), the drinking dish (2) and reservoir (14), in particular its bottom region (9), lying in a common plane (E), and an ascertaining of the residual quantity and/or ascertaining of the speed of removal of the food taking place in the reservoir (14).

12. The device as claimed in claim 11, characterized in that the drinking dish (2) is assigned a residual-quantity-measuring device.

13. The device as claimed in claim 11, characterized in that sensors (8), filling-level sensors, scales or at least one pressure sensor is/are assigned to the drinking dish (2) for ascertaining the residual quantity.

14. The device as claimed in claim 11, characterized in that at least one activatable discharge valve (11) is assigned to the drinking dish (2) in the bottom region for the purpose of cleaning and/or emptying a remaining residual quantity of liquid food.

15. The device as claimed in claim 11, characterized in that the food can be supplied from the food source (1) to the drinking dish (2) in a preportioned quantity on an individual animal basis.

16. The device as claimed in claim 11, characterized in that the food source (1) is connected to the reservoir (14).

17. The device as claimed in claim 11, characterized in that at least one valve (4) and/or a pressure reducer (19), activated by at least one controller (5), is/are inserted into the supply line (3), the supply line (3) leading into the reservoir (14).

18. The device as claimed in claim 11, characterized in that the reservoir (14) has at least one pressure sensor (20) and/or a float device (21) which are connected to the at least one controller (5).

19. The device as claimed in claim 18, characterized in that a filling level of the drinking dish (2) or of the reservoir (14), and/or an ascertaining of the residual quantity and/or an ascertaining of the speed of removal of the food from the drinking dish and/or a top-up speed and/or portion size of the food from the food source (1) the reservoir (14) can be determined, regulated and/or controlled via the at least one pressure sensor (20) and/or the at least one float device (21).
